(19) United States
(12) Patent Application Publication
(10) Pub. No.: US 2012/0081391 A1
(43) Pub. Date: Apr. 5, 2012

(54) METHODS AND SYSTEMS FOR ENHANCING PRESENTATIONS

(76) Inventor: Kar-Han Tan, Sunnyvale, CA (US)

(21) Appl. No.: 12/897,872

(22) Filed: Oct. 5, 2010

(51) Int. Cl. G09G 5/00

(52) U.S. Cl. 345/620; 345/629

(57) ABSTRACT

This disclosure is directed to methods and systems for enhancing presentations. In one aspect, a method for enhancing presentations include capturing images of a presenter's hand gestures directed to content in a presentation displayed on a monitor viewed by the presenter and rending virtual shadow representations of the presenter's hand gestures. Composite images of the virtual shadow representations and the presentation are produced and displayed on a screen. The composite images show the virtual shadow representations and the content of the presentation in a manner that does not block the content of the presentation. Viewers can view the content of the presentation and be visually directed by the virtual shadow representations to the content of the presentation pointed to by the presenter on the monitor.

### TECHNICAL FIELD

This disclosure relates to video presentations.

### BACKGROUND

A person displaying a presentation on a screen for viewing by an audience often has to direct the audience's attention to particular content of the presentation. Presenters often use a hand-held laser pointer to generate a small bright spot of colored light that the presenter uses to direct the audience's attention to the content. However, using a small bright dot to identify content in a presentation displayed on a very large screen to an audience in a large conference room or auditorium may create difficulties for some audience members. For example, audience members located near the back of the auditorium may have trouble visually keeping track of the dot, or audience members may be distracted by trying to find the dot in a brightly illuminated or color filled display of the content. Pointing to content in documents shared over a network may also be difficult for a presenter. Consider, for example, a presenter displaying a presentation that can be viewed on monitors at different remotely situated viewer locations. Any attempt by the presenter to make hand gestures that point to particular elements of the presentation typically cannot be observed by the remotely situated viewers. As a result, persons giving presentations and manufacturers of presentation equipment continue to seek improvements in the presentation experience.

### BRIEF DESCRIPTION OF THE DRAWINGS

FIG. 1A shows a bird's eye view of an example first presentation system.

FIG. 1B shows a side view of a presenter pointing to the screen of a monitor.

FIG. 2 shows an example slide of a presentation and an example image of a presenter's hand used to generate a composite image.

FIG. 3 shows an example of image processing steps used to generate a composite image.

FIG. 4 shows an example of a composite image, with a virtual shadow pointer.

FIG. 5 shows an example of a composite image with an avatar.

FIG. 6A shows a side view of an example second presentation system.

FIG. 6B shows an example of a composite image and an image of the presenter's face displayed on screen.

FIG. 7 shows an example of a presenter sharing documents over a network.

FIG. 8 shows an example schematic representation of a computing device.

### DETAILED DESCRIPTION

This disclosure is directed to methods and systems for enhancing presentations. In particular, methods and systems of the present invention can be used to present composite images of a presentation with a virtual shadow representation of a presenter's hand gestures directed to content of the presentation. The virtual shadow representations are presented to the audience in a manner that does not block the content of the presentation, enabling audience members to view the content of the presentation and be directed by the presenter to particular content of the presentation.

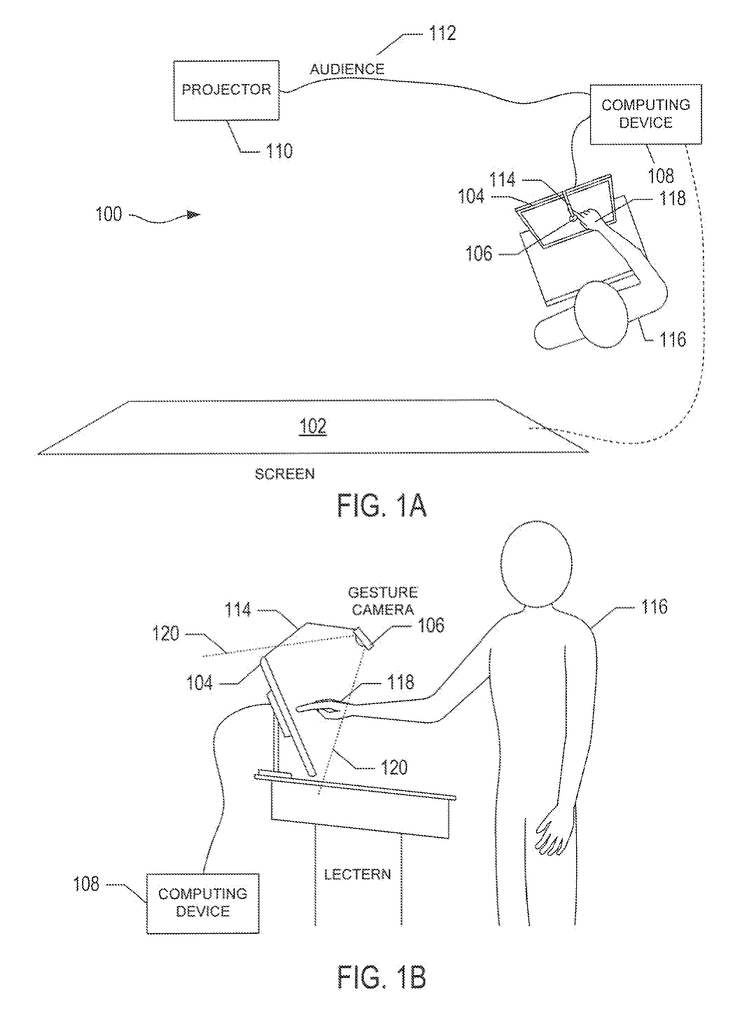

FIG. 1A shows a bird's eye view of an example presentation system 100 for displaying a presentation on a screen 102. The system 100 includes a monitor 104, a gesture camera 106, and a computing device 108. The system 100 may include a projector 110 connected to the computing device 108. The screen 102 can be a projection screen having a surface and a support structure used for displaying images projected by the projector 110 for viewing by an audience 112. Alternatively, the projector 110 can be omitted and the screen 102 can be an electronic video display, such as a large flat-panel television or another computer monitor, connected to the computing device 108. In the example of FIG. 1A, the gesture camera 106 is attached to the frame of the monitor 104 via a flexible extension 114 that enables the gesture camera 106 to be positioned to capture video images of a presenter's 116 hand 118 or objects held by the presenter 116 and capture the content displayed on the monitor 104. In other words, the gesture camera 106 can be positioned to capture images of objects placed between the camera lens and the screen of the monitor 104. Alternatively, the gesture camera 106 can be side mounted and placed closer to a shorter edge of the monitor 104 to create a smaller field of view.

FIG. 1B shows a side view of the presenter 116 pointing to the screen of the monitor 104. As shown in the example of FIG. 1B, the field of view, identified by the dotted lines 120, of the gesture camera 106 includes the hand 118 of the presenter 116 and the screen of the monitor 104. The monitor 104 and computing device 108 can be separate devices, as shown in FIGS. 1A-1B. Alternatively, the monitor 104 and computing device 108 can be combined in a single device, such as a laptop computer placed on the top surface of the lectern.

The presenter creates a presentation using a presentation method encoded in machine-readable instructions that can be stored on the computing device. In the example of FIG. 1A, the presenter 116 operates the computing device 108 to display an enlarged representation of the presentation on the screen 102 for viewing by the audience 112 and simultaneously displays a smaller representation of the same presentation on the monitor 104 for viewing by the presenter 116. Methods of the present invention are directed to processing the presentation and the images captured by the gesture camera 116 to create a composite image composed of the presentation and virtual shadow representations of the presenter's hand gestures. The composite images are presented on the screen 102 enabling the audience 112 to view the content of the presentation undisturbed and simultaneous view virtual shadow representations of the presenter's hand gestures that point to particular elements of the presentation.

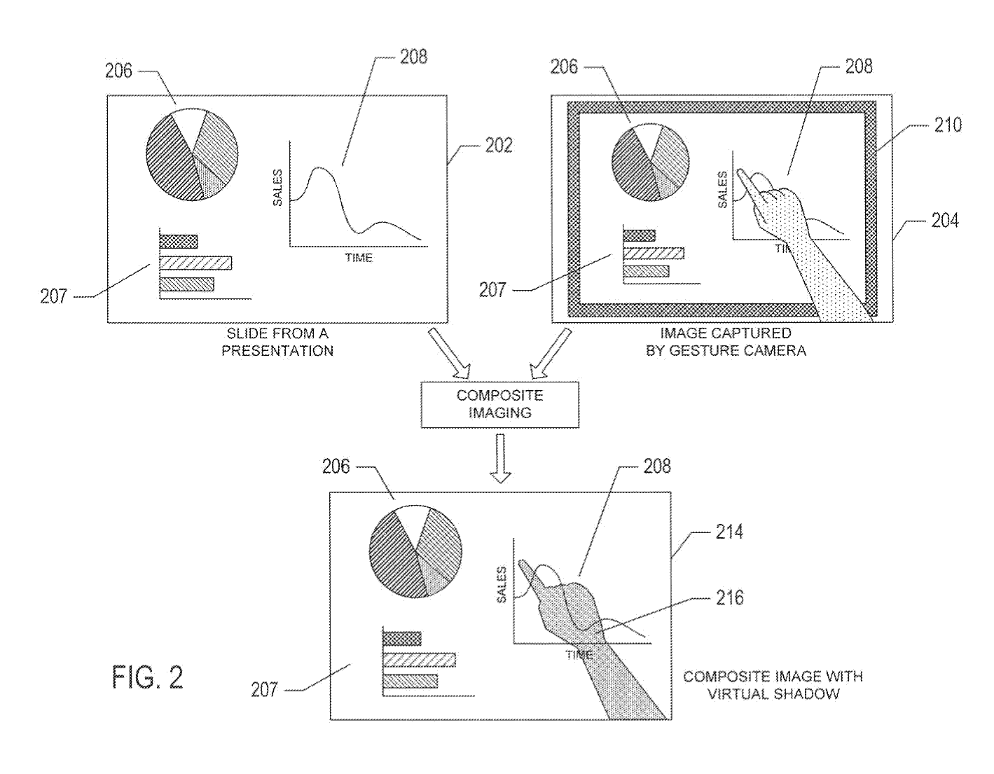

FIG. 2 shows an example slide 202 of a presentation and an example image 204 of a presenter's hand pointing to content displayed on the presenter's monitor. The slide 202 can be generating using any presentation method, and as shown in the example of FIG. 2, includes three types of visual content: a pie graph 206, a bar chart 207, and a sale versus time plot 208. The slide 202 represents the content of the presentation that the presenter intends to the show to an audience and is displayed on the presenter's monitor, enabling the presenter to point to particular content in the slide 202 while the presenter is describing the content of the slide 202 to the audience. The image 204 is captured by a gesture camera and includes the frame 210 of the monitor, the content 206-208 of the slide 202 shown on the monitor, and the presenter's hand 212 pointing to the plot 208. Note that in the image 204, the presenter's hand 216 and a portion of the presenter's forearm block a portion of the view of the slide 202. The slide 202 and image 204 are two separate video streams that are, processed according to composite imaging methods of the present invention, which are described in greater detail below to produce a composite image 214 that is presented to the audience on a screen or display. In the example of FIG. 2, the composite image 214 is a video stream including the original content 206-208 of the slide 202 and a virtual shadow representation 216 of the presenter's hand and arm that does not block the content of the slide 202. The virtual shadow 216, is recognizable to the audience as the presenter's hand pointing to a point in the plot 208. The presenter can make gestures and point at content on the monitor from anywhere between the gesture camera and the screen of the monitor.

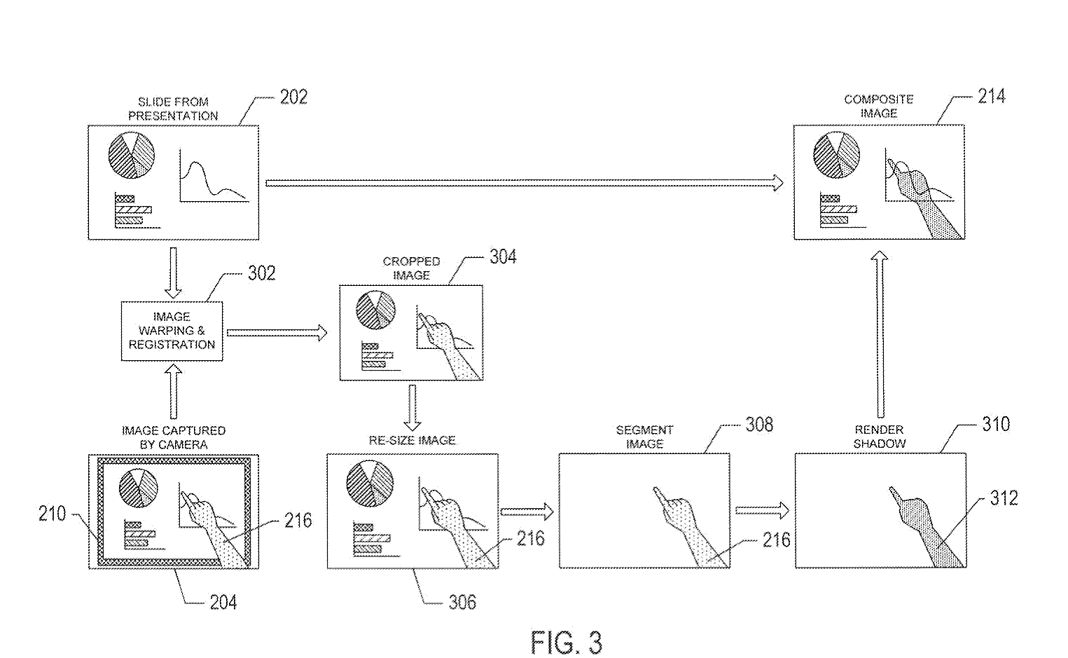

FIG. 3 shows an example of image processing steps used to generate composite image 214 from the slide 202 and image 204. Image warping and registration operations like homography transformations and cropping 302 can be used to compare the contents of the slide 202 to the contents of the image 204 and identify the region of the image 204 that substantially matches the contents of the slide 202. In the example of FIG. 3, the region of the image 204 that substantially matches the content of the slide 202 lies within the frame 210 of the monitor. The frame 210 and portions of the image 204 that lie outside the frame 210 are cropped producing a cropped image 304, which is re-sized to produce a re-sized image 306 with an aspect ratio that substantially matches the aspect ratio of the slide 202. Next, the presenter's hand 216 can be identified in the re-sized image 304 in a number of different ways, including, but not limited to: 1) The brightness differences within the image 306 can be used to distinguish the portions of the image 306 that corresponds to the presenter's hand from the portions of the image 306 that do not. 2) The image 306 can be compared to the slide 202. Portions of the image 306 that do not correspond to the portions of the slide 202 are identified as the presenter's hand 216. 3) In cases where the slide 212 is not a video image, but is a still image, the presenter's hand 216 can be identified by searching for moving objects in the image 306. Once the presenter's hand 216 is identified in the image 306, image segmentation is used to create a segmented image 308 of only the presenter's hand 216. The segmented image 306 is rendered by converting the portion of the image corresponding to the presenter's hand 216 into a virtual shadow image 310 including a virtual shadow representation 312 of the presenter's hand 216. The virtual shadow image 310 is composited with the slide 202 to create the composite image 214.

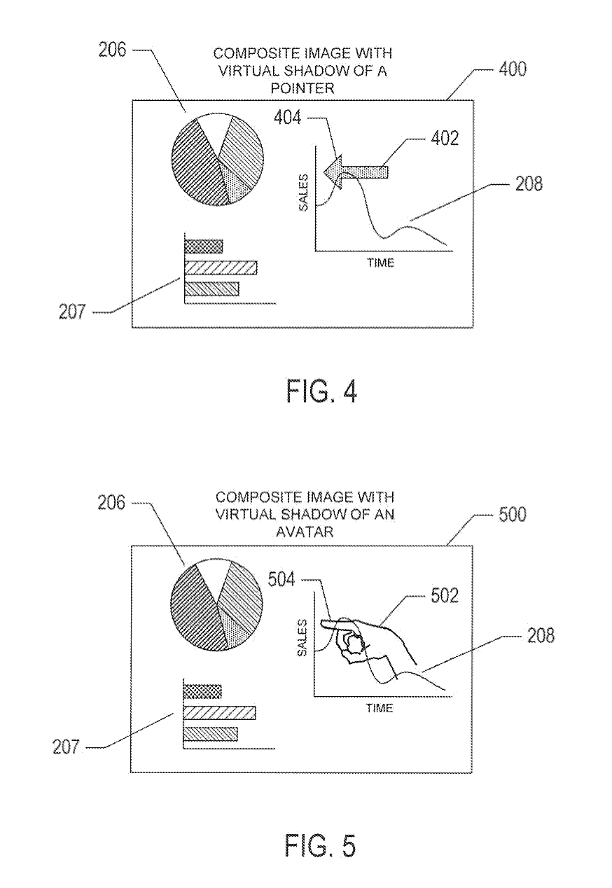

Examples of the present invention are not limited to creating virtual shadow representations of the presenter's hand. The virtual shadow representation of the presenter's had can be a virtual shadow pointer or an avatar. FIG. 4 shows an example of a composite image 400 with a virtual shadow pointer 402. The virtual shadow pointer 402 is composited with the slide 202 so that the tip 404 of the pointer 402 substantially matches the location at which the fingertip of the virtual shadow representation 216 would have been placed. FIG. 5 shows an example of a composite image 500 with an avatar 502. The image of the avatar 502 is composited with the slide 202 so that the fingertip 504 of the avatar 502 substantially matches the location at which the fingertip of the virtual shadow representation 216 would have been placed.

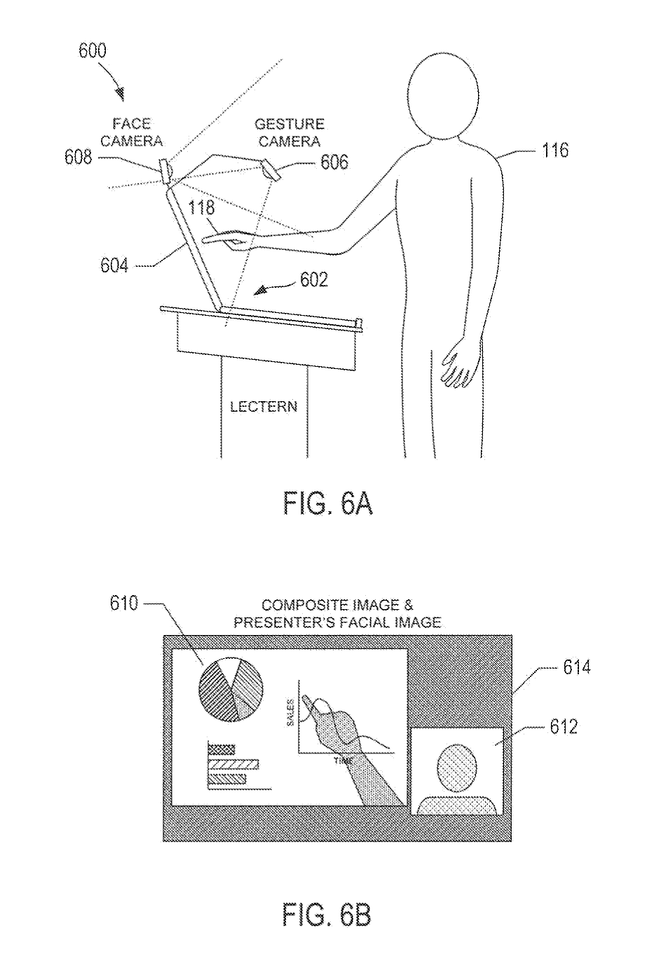

A face camera can also be included to capture images of the presenter, and the image of the presenter can be, displayed along with the composite image of the presentation and the virtual shadow representations of the presenter's hand gestures. FIG. 6A shows a side view of an example presentation system 600. In the example of FIG. 6A, the system 600 includes a laptop computer 602, a gesture camera 606 mounted on the monitor 604 of the laptop 602, and a face camera 608. The laptop 602 and gesture camera 606 are operated in the same manner as the monitor 104, computing device 108, and gesture camera 106 described above with reference to FIG. 1. The face camera 608 can be externally mounted, as shown in FIG. 6A. Alternatively, the face camera can be embedded in the frame of the monitor 604. The gesture camera 606 can be used to create composite images of the presentation and virtual shadow representations of the presenter's hand gestures captured between the gesture camera 606 and the screen of the monitor 604 and the face camera 608 can be used capture images of the presenter's face. FIG. 6B shows an example of a composite image 610 and an image 612 of the presenter's face displayed on screen 614. The composite image 610 can be generated as described above with reference to FIGS. 2-3.

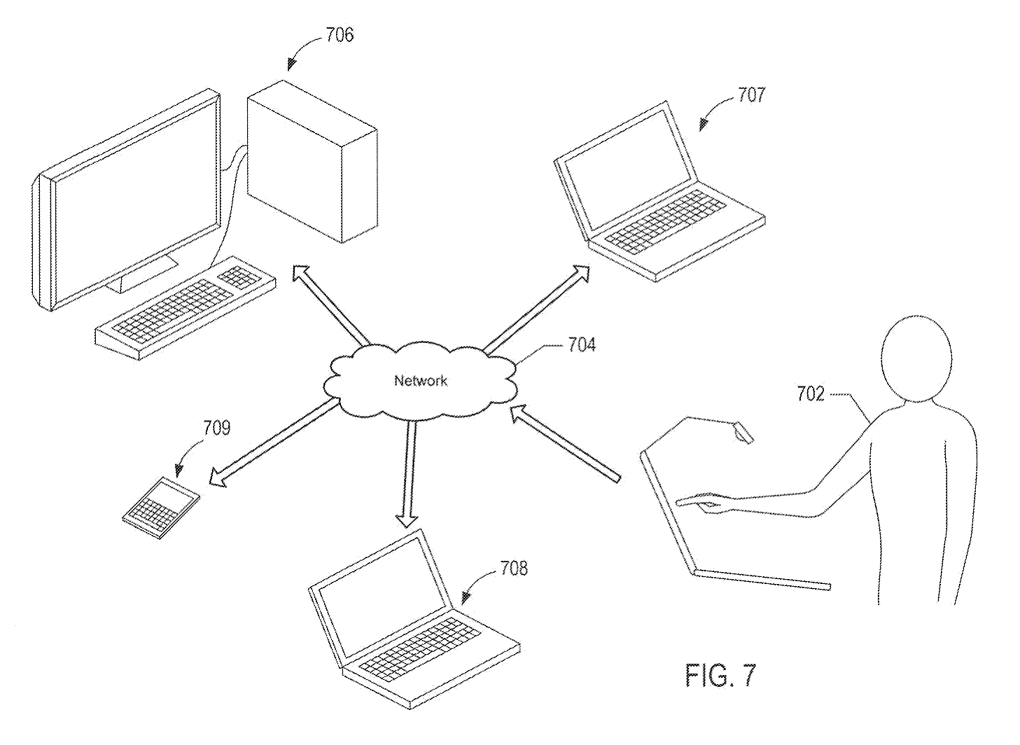

Systems and methods of the present invention are not limited to displaying composite images on a single screen viewed by an audience. The composite images can be viewed on monitors at different viewer locations as a way to display and share documents of a presentation over a network. FIG. 7 shows an example of a presenter 702 sharing documents over a network 704, such as the Internet. In the example of FIG. 7, the presenter 702 generates composite images of the shared documents and virtual shadow representations of the presenter's hand gestures, as described above, and sends the composite images to a variety of different computing devices 706-710 located at different sites.

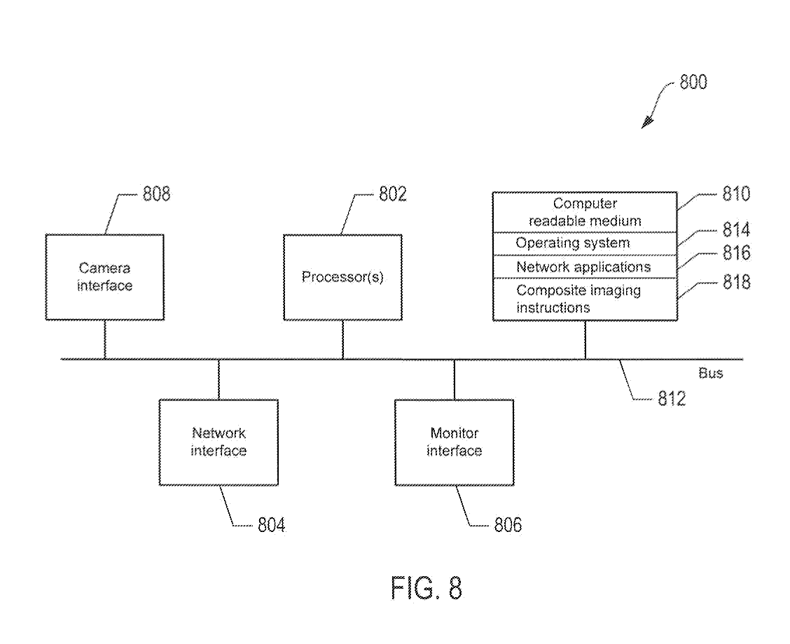

Methods of generating composite images are described above with reference to a computing device. The computing device can be a desktop computer, a laptop, smart phone, or any other suitable device capable of carrying out image processing and data storage. FIG. 8 shows a schematic representation of a computing device 800. The device, 800 includes one or more processors 802, such as a central processing unit; one or more network interfaces 804, such as a Local Area Network LAN, a wireless 802.11x LAN, a 3G or 4G mobile WAN or a WiMax WAN; a monitor interface 806; a camera interface 808; and one or more computer-readable mediums 810. Each of these components is operatively coupled to one or more buses 812. For example, the bus 812 can be an EISA, a PCI, a USB, a FireWire, a NuBus, or a PDS.

The computer-readable medium 810 can be any suitable medium that participates in providing instructions to the processor 802 for execution. For example, the computer-readable medium 810 can be non-volatile media, such as firmware, an optical disk, a magnetic disk, or a magnetic disk drive; volatile media, such as memory; and transmission media, such as coaxial cables, copper wire, and fiber optics. The computer-readable medium 810 can also store other machine-readable instructions, including word processors, browsers, email, Instant Messaging, media players, and telephony software.

The computer-readable medium 810 may also store an operating system 814, such as Mac OS, MS Windows, Unix, or Linux; network applications 816; and a composite imaging, application 818. The operating system 814 can be multi-user, multiprocessing, multitasking, multithreading, real-time and the like. The operating system 814 can also perform basic tasks such as recognizing input from input devices, such as a keyboard, a keypad, or a mouse; sending output to a projector and a camera; keeping track of files and directories on medium 810; controlling peripheral devices, such as disk drives, printers, image capture device; and managing traffic on the one or more buses 812. The network applications 816 include various components for establishing and maintaining network connections, such as machine-readable instructions for implementing communication protocols including TCP/IP, HTTP, Ethernet, USB, and FireWire.

The composite imaging application 818 provides various machine-readable language components for generating composite images of a presentation and virtual shadow representations of a presenter's hand gestures, as described above. Alternatively, some or all of the processes performed by the application 818 can be integrated into the operating system 814, or the processes of the application 818 may also at least be partially implemented in digital electronic circuitry, or in computer hardware, machine-readable instructions, or in any combination thereof.

The foregoing description, for purposes of explanation, used specific nomenclature to provide a thorough understanding of the invention. However, it will be apparent to one skilled in the art that the specific details are not required in order to practice the invention. The foregoing descriptions of specific, examples of the present invention are presented for purposes of illustration and description. They are not intended to be exhaustive of or to limit the invention to the precise forms disclosed. Obviously, many modifications and variations are possible in view of the above teachings. The examples are shown and described in order to best explain the principles of the invention and its practical applications, to thereby enable others skilled in the art to best utilize the invention and various examples with various modifications as are suited to the particular use contemplated. It is intended that the scope of the invention be defined by the following claims and their equivalents:

1. A method for enhancing presentations using a computing device comprising:
capturing images of a presenter's hand gestures directed to content in a presentation displayed on a monitor viewed by the presenter;
rendering virtual shadow representations of the presenter's hand gestures;
producing composite images of the virtual shadow representations composited with the presentation; and
displaying the composite images on a screen, wherein the composite images show the virtual shadow representations and the content of the presentation in a manner that does not block the content of the presentation, enabling viewers, to view the content of the presentation and be visually directed by the virtual shadow representations to the content of the presentation pointed to by the presenter on the monitor.

2. The method of claim 1, wherein capturing images of the presenter's hand gestures further comprises capturing images the presenter's hands or objects held by the presenter and placed between a gesture camera lens and the screen of the monitor.

3. The method of claim 1, wherein rendering virtual shadow representations further comprises:
resizing the aspect ratio of the images of a presenter's hand gestures to substantially match the aspect ratio of the presentation;
segmenting the presenter's hand gestures from other content in the images of a presenter's hand gestures; and
converting the segmented presenter's hand gestures into the virtual shadow representation.

4. The method of claim 3, wherein rendering the virtual shadow representations further comprises cropping the images of a presenter's hand gestures to remove content other than the presenter's hand gesture from images of a presenter's hand gestures to substantially match the content of the presentation.

5. The method of claim 1, wherein the virtual shadow representation further comprises a virtual shadow representation of the presenter's hand pointing to content in the composite image that corresponds to content pointed to by the presenter in the presentation displayed on the monitor.

6. The method of claim 1, wherein the virtual shadow representation further comprises a virtual shadow representation of a pointer having a tip pointing to content in the composite image that corresponds to content pointed to by the presenter in the presentation displayed on the monitor.

7. The method of claim 1, wherein the virtual shadow representation further comprises an avatar pointing to content in the composite image that corresponds to content pointed to by the presenter in the presentation displayed on the monitor.

8. A computer-readable medium having instructions encoded thereon for enhancing presentations, the instructions enabling One or more processors to perform the operations of:
capturing images of a presenter's hand gestures directed to content in a presentation displayed on a monitor viewed by the presenter;
rendering virtual shadow representations of the presenter's hand gestures;
producing composite images of the virtual shadow representations composited with the presentation; and
displaying the composite images on a screen, wherein the composite images show the virtual shadow representations and the content of the presentation in a manner that does not block the content of the presentation, enabling viewers to view the content of the presentation and be visually directed by the virtual shadow representations to the content of the presentation pointed to by the presenter on the monitor.

9. The medium of claim 8, wherein rendering virtual shadow representations further comprises:
resizing the aspect ratio of the images of a presenter's hand gestures to substantially match the aspect ratio of the presentation;
segmenting the presenter's hand gestures from other content in the images of a presenter's hand gestures; and
converting the segmented presenter's hand gestures into the virtual shadow representation.

10. The medium of claim 9, wherein rendering the virtual shadow representations further comprises cropping the images of a presenter's hand gestures to remove content other than the presenter's hand gesture from images of a presenter's hand gestures to substantially match the content of the presentation.

11. The medium of claim 8, wherein the virtual shadow representation further comprises a virtual shadow representation of the presenter's hand pointing to content in the composite image that corresponds to content pointed to by the presenter in the presentation displayed on the monitor.

12. The medium of claim 8, wherein the virtual shadow representation further comprises a virtual shadow representation of a pointer having a tip pointing to content in the composite image that corresponds to content pointed to by the presenter in the presentation displayed on the monitor.

13. The medium of claim 8, wherein the virtual shadow representation further comprises an avatar pointing to content in the composite image that corresponds to content pointed to by the presenter in the presentation displayed on the monitor.

14. A presentation system comprising:
a computing device including one or more processors and memory;
a monitor connected to the computing device;
a camera connected to the computing device; wherein the memory has instructions encoded thereon for enhancing a presentation, the instructions enabling the one or more processors to perform the operations of:
capturing images of a presenter's hand gestures directed to content in a presentation displayed on the monitor viewed by the presenter;
rending virtual shadow representations of the presenter's hand gestures;
producing composite images of the virtual shadow representations composited with the presentation; and
displaying the composite images on a screen, wherein the composite images show the virtual shadow representations and the content of the presentation in a manner that does not block the content of the presentation, enabling viewers to view the content of the presentation and be visually directed by the virtual shadow representations to the content of the presentation pointed to by the presenter on the monitor.

15. The system of claim 14, wherein the camera is positioned to capture the images of the presenter's hands or objects held by the presenter placed between a camera lens and the screen of the monitor.

16. The system of claim 14, wherein rendering virtual shadow representations further comprises:
resizing the aspect ratio of the images of a presenter's hand gestures to substantially match the aspect ratio of the presentation;
segmenting the presenter's hand gestures from other content in the images of a presenter's hand gestures; and
converting the segmented presenter's hand gestures into the virtual shadow representation.

17. The system of claim 16, wherein rendering the virtual shadow representations further comprises cropping the images of a presenter's hand gestures to remove content other than the presenter's hand gesture from images of a presenter's hand gestures to substantially match the content of the presentation.

18. The system of claim 14, wherein the virtual shadow representation further comprises a virtual shadow representation of the presenter's hand pointing to content in the composite image that corresponds to content pointed to by the presenter in the presentation displayed on the monitor.

19. The system of claim 14, wherein the virtual shadow representation further comprises a virtual shadow representation of a pointer having a tip pointing to content in the composite image that corresponds to content pointed to by the presenter in the presentation displayed on the monitor.

20. The system of claim 14, wherein the virtual shadow representation further comprises an avatar pointing to content in the composite image that corresponds to content pointed to by the presenter in the presentation displayed on the monitor.
